(19) United States
(12) Patent Application Publication
(10) Pub. No.: US 2025/0107494 A1
(43) Pub. Date: Apr. 3, 2025

(54) PRESSURIZED GREENHOUSE

(71) Applicant: Rimaco Greens Inc., Calgary (CA)

(72) Inventors: Ricardo Solano Gomez, Calgary (CA); Maria Consuelo Pardo de Solano, Calgary (CA); Angela Maria Solano, Calgary (CA); Maria Alejandra Solano Pardo, Calgary (CA)

(21) Appl. No.: 18/478,357

(22) Filed: Sep. 29, 2023

(51) Int. Cl. A01G 9/24; A01G 9/14

(52) U.S. Cl. CPC A01G 9/246; A01G 9/1407

(57) ABSTRACT

A pressurized greenhouse and air conditioning system designed to optimize plant growth environments. The pressurized greenhouse includes a frame with a transparent covering membrane, vertical fans for maintaining uniform climate conditions, and a pressure control system to manage air intake and exhaust. To achieve precise temperature control, the air conditioning system employs evaporative cooling, air-water heat exchange, and a thermal battery heat exchanger. It circulates air using horizontal fans and utilizes stored thermal energy for heating and cooling modes. Heat rejection means, such as cooling towers or chillers, further enhance efficiency. This inventive system offers comprehensive climate control capabilities for optimal plant growth, making it an essential tool for greenhouse cultivation.

### FIELD OF THE INVENTION

The present invention relates to plant growth systems in greenhouses and, more specifically, to a pressurized greenhouse and air conditioning system designed to maintain optimal climate conditions for plant growth while efficiently managing temperature and humidity.

### BACKGROUND OF THE INVENTION

Traditional greenhouses have often struggled to provide consistent and controlled environmental conditions in the growing space. Temperature fluctuations, humidity imbalances and inadequate ventilation can limit plant growth, affecting crop yield. Furthermore, the energy requirements in managing these non-optimized spaces can be substantial, impacting both greenhouse operations' cost and environmental footprint.

In times of unprecedented food supply crisis and extreme environmental conditions, the interest in indoor growing systems in agriculture has increased exponentially. At the same time, the available technology for Controlled Environment Agriculture (CEA) has not been able to catch up with the increasing demand for sustainable practices by governments and consumers, where energy consumption and use of pesticides make the top of the list. Food security and sustainability have been addressed as two separate challenges, so solutions developed for one have often negatively impacted the other as efforts to increase yields or food quality have come at the cost of rising environmental impact. Immediate action is required to find and implement solutions that will assure local access to affordable food and sustainable practices.

Existing commercial food production methods force people to choose between “clean” (pesticide-free) food, sustainable use of non-renewable resources, and a low carbon footprint. The traditional open field method consumes the lowest amount of energy but requires the highest water consumption and large areas of fertile, arable land. In addition, pesticides and fungicides are unavoidable when growing outdoors. This has a significant impact on consumer health and the environment.

The controlled-environment commercial greenhouse emerged as the solution to reduce water consumption and the need for arable land. Greenhouses are designed to provide a closely controlled microclimate to facilitate plant growth and production, which offers benefits like location flexibility, year-round production, and much higher efficiency than the traditional open-field method. This conventional climate control system is effective but highly inefficient, and it does not eliminate the need for pesticides because the cooling system forces a connection with the outside environment. It consumes a lot of energy as it is forced to respond to sudden daily and seasonal changes in outdoor conditions. Furthermore, the strenuously created indoor environment must be re-created with every energy-wasteful air exchange.

Urban vertical farming, an expanding multimillion-dollar business, guarantees pesticide-free, fresher produce by growing food in an isolated environment within the city. A significant benefit of the sealed environment is the elimination of pesticide-related health risks for consumers and food production workers. This approach consumes even less water than commercial greenhouses and requires minimum land use.

The significant disadvantages of this method are the unprecedented capital costs and carbon footprint. The highest-efficiency artificial lighting technology cannot compare to sunlight—a freely-accessible source of light and energy with zero carbon footprint. Any technology that seeks to replace with artificial means the vast amount of sun light required to respond to the rising demand for food is not a sustainable solution and adds a new layer to existing environmental, climate, and economic problems.

Passive greenhouses were introduced as a way to reduce the high energy consumption of traditional greenhouses. Technologies based on both geothermal and water thermal mass—the ability of a material to absorb, store and release heat—have been available for centuries. Still, their limited size and low reliability, especially in extreme climates, have impeded their adoption for commercial food production. As for the present challenge, neither technology is efficient enough to cool down a sealed greenhouse.

Today, sealed greenhouses allow to steadily maintain the optimal climate conditions for the same air volume and eliminate the need for pesticides while still taking advantage of sunlight to avoid the financial and environmental costs of artificial lighting exposed to solar radiation sealed greenhouses act as heat collectors, they require a powerful cooling system capable of maintaining suitable climate conditions. Unfortunately, existing cooling methods for sealed greenhouses use power-hungry air conditioning systems with high capital and operating costs, which makes them non-viable for food production; in fact, sealed greenhouses are standard in the lucrative cannabis business. In addition, the high environmental price of this cooling method is expected to become unsustainable.

A low energy-consuming air cooling, heating, and dehumidifying process would make it possible to create a closely controlled microclimate that enables a commercial-size greenhouse to guarantee a pest-free environment for plant cultivation and cost-effective year-round operation, with minimal water and energy consumption. A sustainable hydrologic air conditioning system would adapt elements of the Earth's natural hydrologic cycle to efficiently regulate temperature and humidity—by using the solar thermal energy collected during the day and outdoor cold air temperature during the night, a natural, self-regulated thermal balance could be achieved through a specifically designed arrangement of components operating in synergy to collect, store, release, and reject thermal energy to maintain optimal crop-growing conditions.

A pressurized greenhouse with a sealed design that serves the purpose of isolation from outdoor contamination and challenging climate conditions can also act as a solar thermal energy collector. When the solar thermal energy captured inside the sealed environment is in excess, the temperature can be controlled with a rate of water sent to a fogging system, which cools the air using evaporation. The air humidity level could be maintained by having air flowing through a condensing system of air-water heat transfer units that cool and dry the air while transferring its excess heat energy to circulating water. Such a system could take advantage of the water thermal mass of a thermal energy battery—the capacity of water to absorb heat energy, store it, and later release it.

When solar thermal energy is insufficiently available, and the system starts losing heat to the outdoors, heat energy stored in the battery is released to the greenhouse using efficient and effective heat transfer methods. Means for continuous condensate recovery and recycling of the water evaporated in the cooling process and by the plants' transpiration are also integrated into the system.

### SUMMARY OF THE INVENTION

The present invention provides a pressurized greenhouse and an air conditioning system to address these challenges. The invention encompasses several key elements and innovative features.

The first aspect of the present invention is a pressurized greenhouse comprising a frame partially or totally covered by a non-porous, at least partially transparent, membrane. The greenhouse has a frame supporting a non-porous covering membrane that defines an enclosed space conducive to plant cultivation. The frame should be constructed to support the greenhouse structure, and the non-porous covering membrane must be made of suitable materials such as plastic or glass.

The covering membrane includes at least one side wall or a roof portion, and is at least partially transparent, allowing sunlight to penetrate. Inside the greenhouse space, a floor covering is sealed to the bottom edge of the greenhouse walls, ensuring a sealed environment. This membrane should be transparent or semi-transparent, allowing sunlight to pass through for photosynthesis.

The floor covering must be installed so that it is sealed to the bottom edge of the greenhouse walls, preventing any leaks or air exchange with the external environment.

To help maintain uniform climate conditions, a plurality of vertical fans is strategically positioned near the top section of the greenhouse roof To maintain isolation, the created enclosure relies on the pressure control means, which comprises a primary pressure vent, a secondary pressure vent, an active air intake device, and an under-pressure vent mechanism. These components collectively ensure that the greenhouse operates within specified pressure parameters, contributing to an ideal environment for plant growth independently from the outside conditions and preventing pest entrance.

The pressure control consists of multiple components, including a hinged outward-opening vent capable of opening to vent atmospheric air inside the greenhouse space when the static pressure exceeds a primary pressure setpoint. This setpoint should be above the target operating pressure for the greenhouse. A secondary pressure vent should be a hinged outward-opening vent that opens when the static pressure exceeds a secondary pressure setpoint above the primary pressure setpoint.

An active air intake device must connect the external environment and the greenhouse space, pumping outdoor air into the greenhouse when the operating pressure falls below a selected lowest operation pressure setpoint. An under-pressure vent mechanism should open to permit passive air intake from the external environment when the operating pressure inside the greenhouse falls below the lowest operation pressure setpoint and the active air intake device fails.

In certain embodiments, the pressurized greenhouse can include a dual-door transition entrance. This entrance connects the greenhouse space and the outdoor environment, and its operation is designed to maintain the operating pressure inside the greenhouse space during the ingress or egress of people or materials. It should be designed to effectively maintain the operating pressure inside the greenhouse space when people or materials enter or exit.

An air conditioning system designed explicitly for the greenhouse space is also disclosed. This system incorporates various components to control temperature and humidity levels within the greenhouse, ensuring optimal conditions for plant growth. It includes an evaporative cooling system, an air-water heat exchanger, horizontal fans, a thermal battery heat exchanger, a conduit, a water recirculation pump, and an indoor-air-flow mechanism. The invention also encompasses a method for operating this system.

The evaporative cooling system should be designed to evaporate water into the low-humidity air within the greenhouse space, effectively cooling the environment.

The heat exchanger must be mounted within the greenhouse space and include a water inlet and an outlet for water circulation. It should also have a drip pan to capture condensate.

The horizontal fans should be strategically placed near the air-water heat exchanger to create a horizontal airflow across it and through the greenhouse space.

The thermal battery heat exchanger comprises a water-containing shell section with a water inlet and a water outlet. It should also include a plurality of airflow tubes with heat transfer surfaces and condensate drains. The conduit connects the water outlet of the air-water heat exchanger to the water inlet of the thermal battery heat exchanger, allowing for the circulation of water between these components.

The water recirculation pump should have a recirculation intake and a recirculation discharge. The intake connects to the water outlet of the thermal battery heat exchanger, while the discharge is connected to the water inlet of the air-water heat exchanger. This mechanism collects air from the greenhouse space near the air-water heat exchanger and injects it into the air flow tubes of the thermal battery heat exchanger.

The air conditioning system uses a method that sets a target operating temperature and heating and cooling temperature setpoints above and below the target temperature. The horizontal fans are activated to circulate air across the greenhouse space. When the temperature within the greenhouse space reaches one of the heating or cooling temperature setpoints, a corresponding mode of operation is activated.

The evaporative cooling system is activated in the cooling mode until the target operating temperature is reached. The mechanical indoor airflow mechanism also injects air for further cooling into the thermal battery heat exchanger. Further cooled air is released into the greenhouse space, whereby low humidity allows continuous evaporative cooling. Water exiting the air-water heat exchanger is recirculated back into the thermal battery heat exchanger for thermal energy storage.

Alternatively, in the heating mode of the system and method, the indoor airflow mechanism injects air to be heated into the thermal battery heat exchanger before release into the greenhouse space. Water from the air-water heat exchanger is recirculated back into the thermal battery heat exchanger for thermal energy storage.

In certain embodiments, the air conditioning system of the present invention includes a heat rejection means that is fluidly connected between the air-water heat exchanger and the thermal battery heat exchanger, enhancing the efficiency and functionality of the air conditioning system. The heat rejection means should be fluidly connected between the air-water heat exchanger and the thermal battery heat exchanger, enabling the transfer and management of heat between these components. The heat rejection means can comprise various options, including a cooling tower, a chiller, a geothermal heat rejection system, or an air cooler.

The water flow path within the system should allow for water circulation from the air-water heat exchanger through the heat rejection means before entering the thermal battery heat exchanger. This arrangement enhances the system's ability to manage heat efficiently.

In certain embodiments, supplemental heating means can be employed when the thermal energy collected in the air-water heat exchanger or stored in the thermal battery heat exchanger is insufficient to maintain the system in heating mode. The supplemental heating means can include various options, such as a waste heat recovery unit, a geothermal heating system, a backup heater, or a boiler, to ensure that heating requirements are met.

Our system makes it possible, with very low water and energy consumption, to sustainably and affordably create, maintain and control climate conditions to grow plants pest-free at a competitive cost in the isolated, exposed to direct solar radiation environment of a permanently sealed and pressurized greenhouse while generating minimal carbon footprint. The capability of the system to effectively and affordably remove all the excess heat from a sealed heat collector to cool it down to a target level without the use of traditional high-cost power-hunger devices, as well as its capability to affordably and easily store inside as much thermal energy as needed to maintain thermal balance and set conditions, constitute its main features.

The system-preferred embodiments make growing any crop in any geographical location inside a sealed greenhouse possible, cancelling the traditional outdoor air exchanges and applying a synchronized interaction between water and air by adapting elements of the Earth's natural hydrologic cycle. This sustainable air conditioning system uses the capacity of the sealed greenhouse to act as a heat collector and the water large thermal mass. To reach the goal of maintaining steady climate conditions in the sealed environment using the facts mentioned above and the natural interactions found in the Earth's natural hydrologic cycle, the system implements a series of thermal energy transfer processes that involve an arrangement of heat transfer units, a continuous cycle of evaporative cooling, condensation, and condensate recovery, serving at the same time to control temperature and humidity levels.

To regulate the temperature in this isolated microclimate, when solar thermal energy is available, the system will collect solar thermal energy in excess to store it using the thermal mass capacity of a large volume of water stored inside the greenhouse while in the absence of solar radiation or when not enough to maintain the indoor target temperature, to compensate for any heat loss to the outdoor the system will release the previously stored solar thermal energy to the isolated environment and along this process the battery of water will regain its capacity to absorb heat completing this way the created hydrologic cycle.

To maintain a set humidity level, the system includes continuous controlled condensation and recovery of water vaporized by plant transpiration and ambient cooling, bringing much less water consumption. The system design includes means and operation modes to address any imbalance in this created hydrologic cycle, giving it the flexibility to operate in any climate and geographical location.

A control system and control methodology for use in components of the greenhouse system disclosed, for the purpose of actuating the various ventilation and heat management components for the purpose of maintaining the desired setpoints within the greenhouse growing climate area are also explicitly contemplated to be within the scope of the present invention.

The method of achieving the desired setpoints or operating environments within the greenhouse of the present invention by actuating the various components of the system using a control system will also be understood to be within the scope hereof.

Various aspects of our sustainable hydrologic air conditioning system may have one or more of the following advantages:
sustainably maintain target growing conditions in any climate for any crop inside a permanently sealed and pressurized commercial-size greenhouse;
low energy consumption and low maintenance;
low carbon footprint operation with a design that considers fossil fuels as the last source of energy;
maintain stable CO2 target levels with minimum waste year-round by not using air changes with the outdoor ambient;
pest-free environment in CEA (controlled environment agriculture) by cancelling the connection with the outdoor while keeping the greenhouse pressurized;
low water consumption as losses from plant transpiration and evaporative cooling are minimized with recovery and recirculation of the evaporated water in a sealed, isolated environment;
production of high-quality distilled water-condensate fogging and nutrient preparation without the rejection of the traditional reverse osmosis system;
increased control over growing conditions for higher yields by managing the same volume of air, allowing to keep parameters within a narrow range independently of sudden outdoor climate changes;
minimizes the impact of heating and cooling on both the grid and the environment;

In summary, the present invention offers an integrated solution to the challenges of maintaining precise environmental conditions in greenhouses, thereby promoting optimal plant growth and resource efficiency. The combination of pressurized greenhouse construction and advanced air conditioning technology ensures that the greenhouse environment remains conducive to plant growth while minimizing energy consumption and environmental impact.

### BRIEF DESCRIPTION OF THE DRAWINGS

To easily identify the discussion of any particular element or act, the most significant digit or digits in a reference number refer to the figure in which that element is first introduced. The drawings enclosed are:

FIG. 1 is a top view of a pressurized greenhouse by one embodiment of the invention;

FIG. 2 is a front view of the greenhouse of FIG. 1;

FIG. 3 is a top view of another embodiment of a greenhouse incorporating the system and elements of the present invention and

FIG. 4 shows one embodiment of an air conditioning system by the present invention.

### DETAILED DESCRIPTION

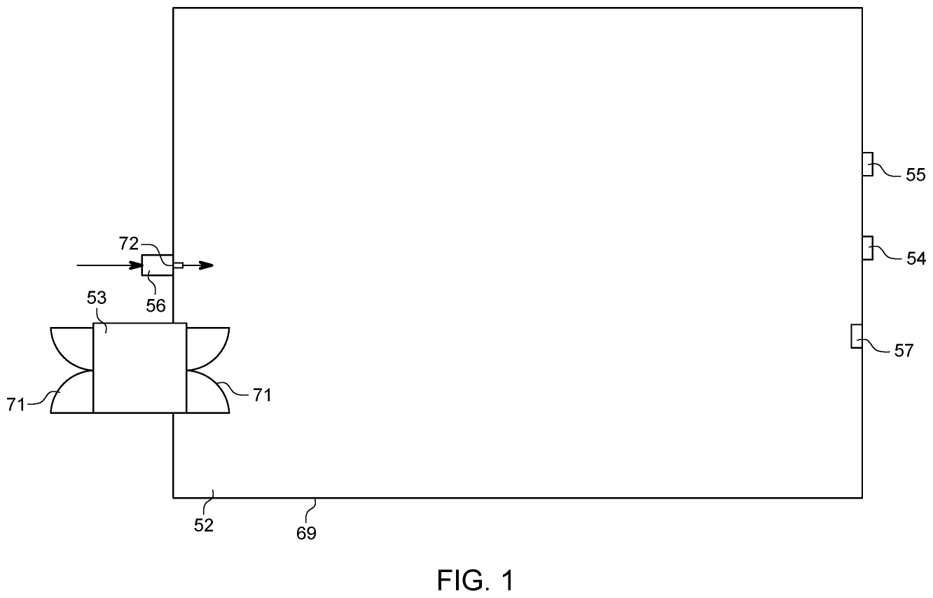

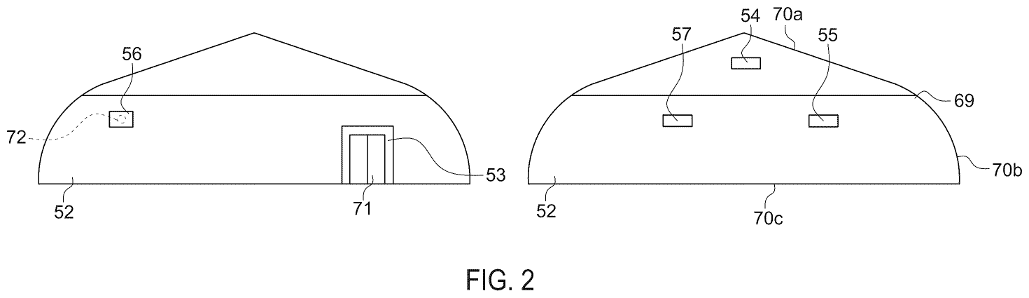

Referring first to FIGS. 1 and 2, one embodiment of a greenhouse 52 is shown by the present invention.

The greenhouse 52 components include a frame 69 assembled out of frame material and a covering membrane made 70 from a non-porous material forming a roof membrane 70a and a wall membrane 70b, as one continuous membrane or air and water-tight connected sections, creating a barrier between the greenhouse interior environment and the outdoor ambient. A non-porous shield covering the ground inside the greenhouse makes its floor cover 70c, with all its perimeter sealed to the wall membrane bottom edge as they meet at the ground level. All of the membrane sections, namely the floor covering 70c, the wall membrane 70b and the roof membrane 70a, are substantially sealed.

The surface assigned for the crops to grow is referred to as the growing area 51.

The covering membrane is at least partially transparent to permit the entrance or transition of solar energy and light through the surface to enable plant growth inside the greenhouse.

An enclosed entrance transition 53 with a door 71 in each of its opposite ends constitutes access to the isolated environment.

Pressure control means are framed in the covering membrane 70, specifically:
a. a primary pressure vent 54 comprising a hinged outward-opening vent which opens to vent atmospheric air from inside the greenhouse space to the external environment when static pressure therein exceeds a primary pressure setpoint which is above a target operation pressure for the greenhouse;
b. a secondary pressure vent 55 comprising a hinged outward-opening vent which opens to vent atmospheric air from inside the greenhouse space to the external environment when static pressure therein exceeds a secondary pressure setpoint which is above the primary pressure setpoint;
c. an active air intake device 56 connecting the external environment and the greenhouse space to pump air from the outdoor environment into the greenhouse space if the operating pressure inside the greenhouse space falls below a selected lowest operation pressure setpoint; and
d. an under-pressure safety vent mechanism 57 that will open to permit passive air intake into the greenhouse space from the external environment if the operating pressure inside the greenhouse space falls below the lowest operation pressure setpoint and the active air intake device fails.

Also shown is a vacuum safety damper-hinged flap 57 with an inward opening with a horizontal axis and a pass-through 72 for the air blower-treatment unit 56 outlet pipe. This air blower-treatment unit 56 contains an actual blower, a HEPA filter and a UV light to constitute at once a mechanical airflow mechanism and a device for outdoor air treatment. The safety damper 57 has a fine bug net covering all its opening areas for filtering in case it enters operation. The quantity and size of all these pressure control devices depend on the size of the greenhouse.

FIG. 2 shows front and back-facing views of the greenhouse of FIG. 1.

Air treatment units 38 constitutes a blower, HEPA filter, carbon filter, and UV light for the enclosed ambient air recirculation and treatment.

A cooling tower 44 for heat rejection has its inlet side connected to piping coming from the air-water heat exchanger HE 35 and thermal battery heat exchanger TBHE 34. Its outlet is connected to piping returning to the TBHE 34.

Also shown in the embodiment of FIG. 2 is a Natural Gas Combined Heat and Power—NG CHP generator 45 as a source of supplemental heat. Its cooling system connects to piping from HE 35 and TBHE 34 and returning piping to enter TBHE 34.

A plurality of vertical fans 49 are mounted near the ceiling and distributed along the greenhouse. Horizontal air fans HAF 50 are placed above the crops and distributed along the greenhouse facing the air-water heat exchanger HE 35.

### System:

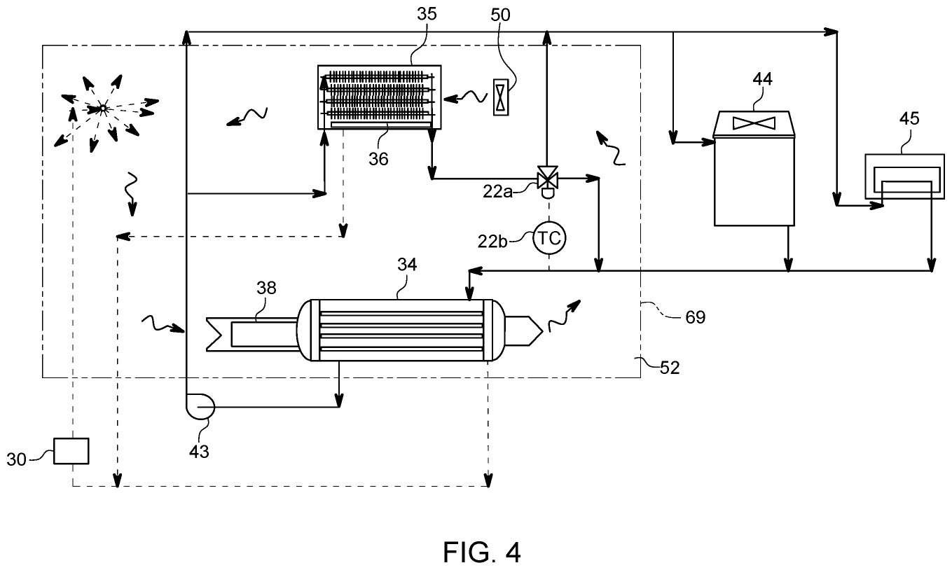

Referring to FIG. 4, a fogging system 30 is shown as a form of evaporating cooling, which includes a condensate treatment/filter, a high-pressure pump, and high-pressure spray nozzles 33.

In addition to the fogging system 30, an air-water heat exchanger HE 35 is shown. It represents a known industrial radiator with a finned tube exchanger configuration, with the fins maximizing the heat transfer surface area by its basic available design. This HE 35 features one condensate collection pan 36 at the bottom, along, and below its finned tubes.

The thermal battery heat exchanger TBHE 34 represents a means for water storage and air-water heat exchange simultaneously. Our preferred embodiment is a shell and tube heat exchanger containing a large volume of water in the shell section while air flows through the tubes, constituting its heat transfer surface. Taking advantage of the large volume of water stored in its shell side, the system stores thermal energy in the water to be released later, making it a thermal battery heat exchanger. Recirculation water pump 43 moves the recirculating water.

A temperature control valve 22A is located in the piping exiting the air-water heat exchanger 35. The temperature sensor 22B of the said control valve 22A is located just before the entrance to the TBHE 34.

### Basic Operations:

As shown, the embodiment of the present invention will operate to create crop growing conditions inside a permanently sealed, pressurized greenhouse 52 with a membrane 70, so the system can use the maximum possible of the collected inside solar thermal energy while taking advantage of the natural sunlight. This sealed and pressurized greenhouse does not need outdoor air ventilation or traditional air exchanges. It maintains environmental isolation as well as setting a positive static pressure in the greenhouse within a narrow range close to a set target operating pressure. Static pressure inside the sealed greenhouse will naturally happen with plant oxygen production, CO2 injection, and thermal expansion.

The system operates in modes that run harmoniously, responding to the system's demand for heat to maintain thermal balance. There are four operation modes two of them leading operation modes and two additional auxiliary operation modes:
a) A solar energy collection mode permits the harvesting and storage of solar thermal energy;
b) a thermal energy-releasing mode- to release stored solar thermal energy;
c) heat rejection mode-auxiliary mode of operation; and
d) supplemental heat collection mode-another auxiliary mode of operation.

At any moment when stored thermal energy is insufficient to assure the conditions to maintain thermal balance, the system runs one of the auxiliary operation modes to reject any heat in excess or collect supplemental heat to cover any deficiency. Featuring a thermal battery gives the system the possibility to accomplish both of these two auxiliary modes of operation at any time which allows the system to avoid peak periods of energy consumption, look for proper conditions to achieve the best results, and use reduced-size means for heat rejection and supplemental heat collection as they can run independently during an extended period to accumulate results in its battery over time at a very low rate.

In operation, the system itself has two main objectives:
1. to maintain year-round stable climate conditions inside a sealed and pressurized greenhouse responding to set conditions that include target temperature, humidity, and air quality; and
2. to reach the preset conditions at the end of each operating mode to assure the system thermal balance during the following operating mode.

To maintain stable climate conditions, the system uses evaporative cooling as the system requests, harvests solar thermal energy when in excess, condenses evaporated water to control humidity, and treats recirculating air. In pursuit of its second objective to assure system thermal balance, the system permanently maintains stored thermal energy in its battery at a proper level.

Heat rejection is also an essential part of system operation. Heat rejection is done during a specific mode of operation, as soon as solar thermal energy is collected and before it reaches storage—heat rejection also happens by removing excess thermal energy already in storage to regain set storage conditions. It can be done at any time.

### Solar Energy Collection Mode:

To maintain greenhouse climate conditions, the system provides proper air circulation, applies evaporative cooling, recovers condensate, and includes heat rejection when in demand while operating three integrated heat exchange processes.

Fogging system 30, as a demonstrative evaporative cooling method, sprays a mist of water which absorbs enough heat from the surrounding air to vaporize, cooling the air while increasing its humidity. The air will fail to hold additional vapour when it becomes saturated with water, so a controlled air humidity level makes it possible to continue this evaporative cooling.

Latent heat constitutes the amount of heat exchanged without a change in temperature, like fogging, while sensible heat relates to heat exchange with a change in temperature, like warming water. The temperature difference between circulating water's crossing flows in the air-water heat exchanger HE 35 and the greenhouse circulating humid air drives a latent heat transfer where latent heat in the humid air transforms into sensible heat in the circulating water. To maintain the driving force between these two crossing flows, a sufficient volume of water-thermal mass is stored in the system thermal battery-TBHE 34 to cover the demand for it during the entire duration of the solar energy collection mode of operation. A significant amount of water flowing into this HE 35 assures a limited increase in circulating water temperature, meaning stable conditions in the thermal battery TBHE 34. During this mode of operation, air-water heat exchanger 35 works as a cooler-dehumidifier by cooling the circulating air below its dew point, producing condensate.

The TBHE 34 transforms latent heat in the humid air passing through its tubes into sensible heat in the water it contains in its shell side to release dry and cooler air to the greenhouse environment. This process completes a cycle with the fogging as this air coming out of the TBHE 34 with a lower humidity level regains its capacity to contain vaporized water.

The three heat exchange processes described above happen fluently following the arrangement of heat transfer units with fluids moving in counter-flow and crossflow. Starting with Heat Exchange 1, above the growing area 51, the HAF 50 moves air heated by the sun radiation across the greenhouse towards the air-water heat exchanger HE 35. This air reaches its warmest temperature along this path, which means it will be at its lowest water saturation and at the optimal point to apply evaporative cooling—fogging. Next comes Heat Exchange 2, where the circulating water from TBHE 34 cools more humid, warm air as these two fluids meet in crossflow at HE 35. Finally, Heat Exchange 3, where the cooler and less humid air close to the HE 35 at a level below the growing area, flows into the TBHE 34 for additional cooling.

This overall arrangement for the three heat exchange processes maintains the maximum possible driving force through all heat transfer areas, minimizing the difference in final air and water temperatures and maintaining a stable temperature range inside the sealed pressurized environment.

The system operation permanently controls the in-greenhouse humidity level by cooling the circulating air below its dew point, forming condensate in the HE 35 and TBHE 34. The system collects and recycles this condensate so it recovers the typical water loss from plant transpiration and evaporative cooling while controlling humidity. This high efficiency in managing water condensation means effective and close humidity control, improved rate of plant growth, and the possibility to continuously use evaporative cooling-fogging without humidity level limitations. Condensate recovery results in minimal water loss and the production of valuable, high-quality distilled water—condensate, for fogging and crop nutrient preparation.

Vertical fans 49 assure complete coverage of the top air space to prevent air stratification. The horizontal air fans HAF 50 send air across the greenhouse toward the HE 35. The air treatment unit 38 takes in greenhouse air near the HE 35 to flow through the TBHE 34 to be released at the opposite end of the greenhouse.

Excess heat rejection can be part of the operation during the solar energy collection mode using the system capability to reject collected thermal energy over what is required for storage to assure thermal balance in the future and, at the same time, to collect solar energy, removing excess heat from the greenhouse ambient to ensure thermal balance at the present time. By permanently maintaining a set water temperature in the TBHE 34, the system establishes conditions for future thermal equilibrium inside the isolated microclimate.

When thermal energy is collected in excess during the solar energy collection mode to maintain that stored water set target temperature in the TBHE 34, the system controls the temperature of the water flowing into the TBHE by diverting it partially or totally towards means for heat rejection before allowing it to return. This constitutes the first possible action for heat rejection during the solar energy collection mode. For the preferred embodiments, a cooling tower acts as the means for heat rejection, but other possibilities include an air cooler, geothermal cooling, chiller, etc.

### Thermal Energy-Releasing Mode:

The thermal energy-releasing mode is the other primary system mode of operation. It applies in the absence of solar radiation or when the system demands additional heat to maintain thermal balance in the growing area due to the loss of thermal energy to the outdoors. During this mode of operation, the system uses thermal energy stored during the previous solar energy collection mode to reach thermal balance.

Previously stored energy inside the TBHE is transferred to the surrounding ambient by natural heat dissipation. When the system demands additional heat transfer area to increase heat release to maintain thermal balance, forced convection applies in two consecutive additions by using the air treatment unit 38 first followed by the water recirculating pump 43 with the horizontal air fans HAF 50 making two additional transfer areas for heat exchange.

In the thermal energy-releasing mode, the air treatment unit 38 starts to move ambient air through the thermal battery heat exchanger TBHE 34—Heat Exchange 4, causing release of stored thermal energy into the circulating air aiming to regain thermal balance inside the greenhouse. When released thermal energy by both dissipation and Heat Exchange 4 is not enough to regain thermal balance, the recirculating pump 43 with the horizontal air fans HAF 50 will start operation to add the finned tubes of the HE 35 to act as additional transfer area to increase the release of stored thermal energy. During this mode of operation, the HE 35 works as a commonly known radiator.

### Heat Rejection Mode:

The heat rejection mode constitutes one of the system's auxiliary operation modes. If excess solar thermal energy is harvested, it can be rejected in accordance with the remainder of the system and method of the present invention, resulting in the system regaining its capacity to collect and store heat. In a case when, at any moment, the amount of stored thermal energy is in excess of what is required to assure thermal balance, the system will start an independent and dedicated heat rejection mode of operation by circulating in loop water flowing from its thermal battery directly to means for heat rejection and back until conditions are reset for the next thermal energy collection mode.

### Supplemental Heat Collection Mode:

The supplemental heat collection mode represents the other auxiliary mode of operation. When the system foresees a demand for thermal energy for thermal balance greater than what is available in storage in the TBHE 34, it can start the supplemental heat collection mode of operation in advance. Water will be directed from the TBHE 34 to a source of supplemental heat to collect heat to be taken back into the TBHE 34 for storage to assure thermal balance. This mode of operation will continue as long as necessary until conditions are restored to ensure thermal balance. For the preferred embodiments a Natural Gas Combined Heat and Power generator-NG CHP generator 45 acts as the source of supplemental heat. Other possible means for additional heat include geothermal heat, a backup heater, a boiler.

The two thermal energy auxiliary modes of operation can run independently from the system's main operation modes to reduce or increase the amount of thermal energy already in storage.

### Detailed Operation Description:

The sustainable hydrologic air conditioning system operates in the preferred embodiments to create and maintain target climate conditions. The substantially sealed greenhouse 52 operable components support the enclosed space at slightly positive pressure. To access the greenhouse climate area, an air shower constitutes the entrance transition 53 to maintain that isolation as the entering person closes the door behind to allow the air shower filtering system to clean the air by removing contaminants from personnel and object surfaces before the door on the opposite end can be opened.

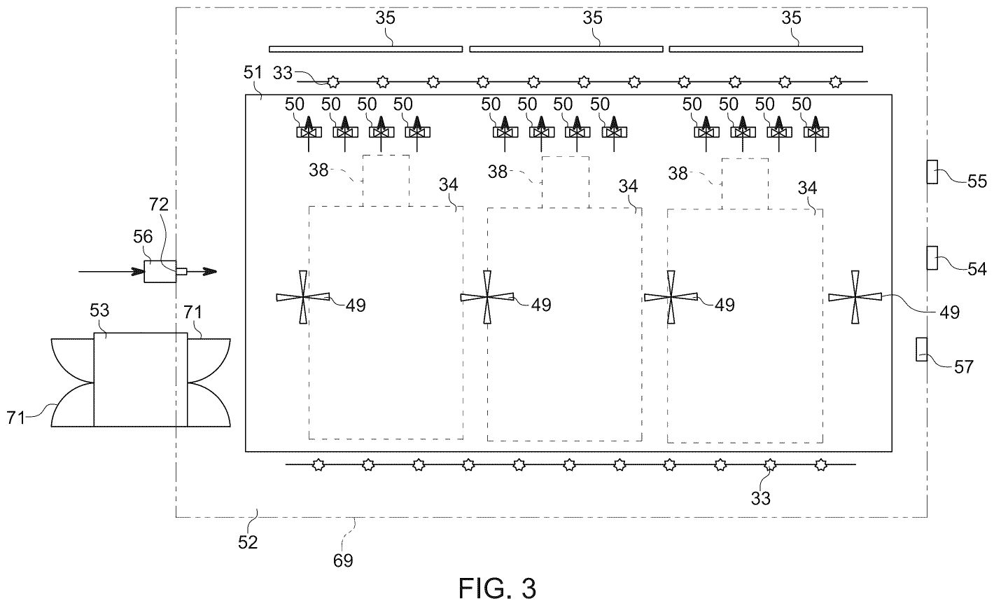

The permanent operation of the means for pressure control of the sealed greenhouse 52 maintains a set positive operating pressure in its enclosed space (FIG. 3). A pressure control damper 54, a hinged flap with an outwards opening, constitutes the primary pressure control device opening as soon as the static pressure in the greenhouse reaches a setpoint over the said set target operating pressure and continues open until static pressure lowers to the said set target operating pressure. If while venting air to the outdoors through the pressure control damper 54, the sealed greenhouse static pressure reaches a second higher setpoint pressure, a pressure control damper 55, a hinged flap with an outwards opening, opens as a secondary pressure control device. Dampers 54 and 55 remain open until the target operating pressure is reached. When the static pressure in the greenhouse lowers to a positive pressure setpoint below the set target operating pressure, an air blower-treatment unit 56 will act by injecting cleaned outdoor air until the greenhouse pressure raises to the set target operating pressure.

A damper 57, a hinged flap with an inwards opening, constitutes a vacuum safety device reacting to a minimum vacuum by allowing outdoor air to flow inside the greenhouse in the event that the said blower 56 fails to start.

Referring now in more detail to the heat collection mode of operation of the air conditioning system, the recirculation water pump 43 circulates water from the thermal battery heat exchanger TBHE 34 to flow through the air-water heat exchanger HE 35 while horizontal air fans-HAF 50 blow humid air past this same HE 35, creating a crossflow with the cooling water flowing along the said HE 35 finned tubes. This fluid crossflow allows excess thermal energy transfer from the humid air in the greenhouse to the water circulating through the HE 35. Next, after passing through this HE 35, the already-warmed circulating water flows out and into the TBHE 34.

The recirculating water continues flowing at a considerably low velocity along the shell side of the TBHE 34, where the collected heat is stored for later release.

Fogging system 30 maintains the greenhouse at a set temperature through evaporative cooling by using high-pressure spray nozzles 33 to atomize water. Hence, water droplets cool the air as they absorb excess thermal energy and evaporate. The horizontal air fans-HAF 50 direct the resulting humid air towards the air-water heat exchanger HE 35, where the crossflow with the water flowing through the HE finned tubes cools the air below its dew point, forming condensate on the surface of the HE 35 finned tubes. A condensate collecting pan 36 below catches this dripping condensate, which will flow by gravity to return to the fogging system for recycling. At the same time, the excess is used for crop nutrient solution preparation. The TBHE 34 serves the purpose of humidity control, air cooling, and air recirculation. Continuing its path, the cooled and less humid air near the HE 35 and below the growing area 51 flows into the air treatment unit 38 for cleaning. It is directed into the TBHE 34, where excess thermal energy is transferred from the circulating air to the water in the shell side of this TBHE 34 to be stored for later use. In contrast, the circulating air is cooled below its dew point, forming condensate, which flows out by gravity to the fogging system for recycling while the excess is used for plant nutrient preparation. The recirculating, now clean, cooler, dry air continues, leaving the TBHE 34 to be released back into the greenhouse open space above the growing area 51, making it the point of supply of conditioned air to restart the air-recirculating cycle.

Vertical fans 49 prevent stratification by blowing the top layers of warm air downwards, contributing to maintaining uniform climate conditions in the sealed environment.

Once the system demand for cooling in the greenhouse has passed, the fogging system 30 will stop. At the same time, the air recirculation will continue operating until the remaining condensate left in the system evaporates into the dry air as a set level of humidity for the coming mode of operation is reached.

Referring to FIG. 4, the heat rejection approach of the invention when happening simultaneously with the thermal energy collection mode of operation is further detailed. To maintain a set temperature for the water stored in the TBHE 34, the system controls the temperature of the recirculating water at its entrance. While recirculating warm water flows from the HE 35 towards the TBHE 34, the temperature control valve 22A regulates the volume of this warm water allowed to enter by using the signal from the temperature sensor 22B to divert the incoming flow partially or totally towards the cooling tower 44 for cooling before it is allowed to re-enter the cycle to flow back into the TBHE 34.

As the created environment demands compensation for thermal energy loss to the outdoor, the air conditioning system initiates the thermal energy-releasing mode of operation, which starts a sequence of stages in response to the demand for thermal energy by the system for thermal balance.

To start, the TBHE 34, by dissipation, slowly transfers to the greenhouse air thermal energy harvested during the previous thermal energy collection mode. At this point, if there is a demand for additional heat transfer area, forced convection applies in two following consecutive stages. First, the air treatment unit 38 enters operation to recirculate greenhouse air through the TBHE 34. Thermal energy is released by the water in the shell side of the said TBHE 34 to the cooler air circulating through its tubes. For additional heat transfer area when still in demand, the second stage of forced convection includes the recirculation water pump 43 and the horizontal air fans 50 to add the transfer area of the HE 35 where thermal energy will be released by the water flowing through it to the air directed in crossflow by the horizontal air fans 50.

At any time during operation, when the control system foresees any imbalance in the created microclimate between the thermal energy harvested during the energy collection mode and the thermal energy dissipated during the thermal energy-releasing mode, it will run in advance one of the auxiliary modes of operation to assure the thermal balance will be maintained.

When the temperature sensor 22B at the entrance of the TBHE 34 sends a signal to the temperature control valve 22A with a value still above but close to the minimum set temperature to be maintained in the TBHE 34, the control system will initiate the supplemental heat collection mode of operation by using the said valve to divert partially or totally, the recirculating water flowing from the HE 35 towards a natural gas combined heat and power generator—NG CHP generator—45, which acts as a source of supplemental heat.

Water flows into the NG CHP 45 engine cooling system to collect the otherwise wasted heat by cooling its engine before flowing into the TBHE 34 to maintain its set operation temperature to ensure enough thermal energy in storage. This mode of operation will continue until the stored water temperature rises to the set operation temperature, assuring enough thermal energy is stored to respond to the demand to maintain thermal balance.

As soon as the system finds that the water temperature in the TBHE 34 increases to a level still below but close to the maximum set temperature, it will start the heat rejection mode of operation. The recirculation water pump 43 will direct water from the TBHE 34 directly to the cooling tower 44 to be sprayed from its top to fall in counter-flow with a rising flow of cool ambient air for heat transfer. Already cooled water flows back to the TBHE to continue this loop operation until the operation set temperature for the thermal battery is reached. The system can run this heat rejection mode of operation at any time that conditions in the TBHE 34 demand heat rejection.

It will be apparent to those of skill in the art that the present invention can be optimized for use in a wide range of conditions and applications by routine modification. It will also be evident to those of skill in the art that there are various ways and designs to produce the apparatus and methods of the present invention. The illustrated embodiments are, therefore, not intended to limit the scope of the invention but to provide examples of the device and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. The terms “comprises” and “comprising” should be interpreted as referring to elements, components, or steps in a non-exclusive manner, indicating that the referenced elements, components, or steps may be present, utilized, or combined with other elements, components, or steps not expressly referenced.

What is claimed is:

1. A pressurized greenhouse comprising:
a. a frame with a non-porous covering membrane thereover defining an enclosed greenhouse space, said covering membrane having a roof portion and at least one side wall and being at least partially transparent to allow sunlight to pass through;
b. a floor covering positioned within the greenhouse space and sealed to the bottom edge of the covering membrane;
c. a plurality of vertical fans attached within the greenhouse space in proximity to the roof portion of the covering membrane, said vertical fans, when actuated, capable of providing uniform climate conditions within the greenhouse space;
d. a pressure control means comprising:
i. a primary pressure vent comprising a hinged outward-opening vent which opens to vent atmospheric air from inside the greenhouse space to the external environment when static pressure therein exceeds a primary pressure setpoint which is above a target operation pressure for the greenhouse;
ii. a secondary pressure vent comprising a hinged outward-opening vent which opens to vent atmospheric air from inside the greenhouse space to the external environment when static pressure therein exceeds a secondary pressure setpoint which is above the primary pressure setpoint;
iii. an active air intake device connecting the external environment and the greenhouse space to pump air from the outdoor environment into the greenhouse space if the operating pressure inside the greenhouse space falls below a selected intake pressure setpoint; and
iv. an under-pressure vent mechanism that will open to permit passive air intake into the greenhouse space from the external environment if the operating pressure inside the greenhouse space falls below the intake pressure setpoint and the active air intake device fails.

2. The greenhouse of claim 1 further comprising a dual door transition entrance connecting the greenhouse space and the outdoor environment, by operation of which the operating pressure inside of the greenhouse space is maintained on ingress or egress of people or material.

3. An air conditioning system for a greenhouse space comprising:
a. an evaporative cooling system for evaporating water into low humidity air within the greenhouse space;
b. an air-water heat exchanger mounted within the greenhouse space and comprising a water inlet and a water outlet for water circulation therethrough and having a drip pan thereunder for capturing condensate therefrom;
c. a plurality of horizontal fans mounted in proximity to said air-water heat exchanger capable of creating a horizontal airflow thereacross and through the greenhouse space;
d. a thermal battery heat exchanger comprising a water-containing shell section having a water inlet and a water outlet, and a plurality of air flow tubes comprising a heat transfer surface and including condensate drain therein;
e. a conduit connecting the water outlet of the air-water heat exchanger to the water inlet of the thermal battery heat exchanger;
f. a water recirculation pump having a recirculation intake and a recirculation discharge, the recirculation intake being connected to the water outlet of the thermal battery heat exchanger;
g. a recirculation discharge conduit connecting the recirculation discharge of the water recirculation pump to the water inlet of the air-water heat exchanger;
h. an indoor-air-flow mechanism that collects air from the greenhouse space in proximity to the air-water heat exchanger for injection into the air flow tubes of the thermal battery heat exchanger;
wherein the system is operated using a method comprising:
a. establishing a target operating temperature having cooling and heating temperature setpoints above and below the target operating temperature for corresponding cooling or heating modes of operation until the target operating temperature is reached, and storing water in the shell section of the thermal battery heat exchanger in advance of operation;
b. actuating the horizontal fans to circulate air across the greenhouse space;
c. when the temperature within the greenhouse space reaches one of the heating or cooling temperature setpoints, activating a heating or cooling mode of operation by:
i. actuating the water recirculating pump to send stored water from the thermal battery heat exchanger to the air-water heat exchanger by the water recirculating pump entering operation;
ii. when the cooling temperature setpoint is detected within the greenhouse space, entering a cooling mode of operation until the target operating temperature is reached by:
1. activating the evaporative cooling system until the target operating temperature is reached in the greenhouse space;
2. actuating the mechanical indoor-air-flow mechanism to inject air for further cooling into the thermal battery heat exchanger;
3. releasing further cooled air from the air tubes back into the greenhouse space where the low humidity allows for continuous evaporative cooling; and
4. recirculating water exiting the air-water heat exchanger after thermal energy collection therefrom back into the thermal battery heat exchanger for thermal energy storage;
iii. when the heating temperature setpoint is detected within the greenhouse space, entering a heating mode of operation until the target operating temperature is reached by:
1. actuating the indoor-air-flow mechanism to inject air to be heated into the thermal battery heat exchanger before release back into the greenhouse space; and
2. recirculating water from the air-water heat exchanger back into the thermal battery heat exchanger for thermal energy storage.

4. The system of claim 3 further comprising heat rejection means fluidly connected between the air water heat exchanger and the thermal battery heat exchanger.

5. The system of claim 4 wherein the heat rejection means comprises any one or more of a cooling tower, a chiller, a geothermal heat rejection system or an air cooler.

6. The system of claim 4 wherein water flow from the air-water heat exchanger is circulated through the heat rejection means before entering the thermal battery heat exchanger.

7. The system of claim 3 further comprising supplemental heating means for use when thermal energy collected in the air-water heat exchanger or stored in the thermal battery heat exchanger is insufficient to operate the system in heating mode.

8. The system of claim 7 wherein the supplemental heating means comprises any one or more of a waste heat recovery unit, a geothermal heating system, a backup heater or a boiler.

9. The system of claim 5, wherein the air conditioning system is capable of performing thermal energy collection and storage, condensation, excess heat rejection, and supplemental heat collection.
